(19) United States
(12) Patent Application Publication
(10) Pub. No.: US 2007/0150367 A1
(43) Pub. Date: Jun. 28, 2007

(54) Method and apparatus for receiving order item, and computer product

(75) Inventors: Nobuo Yuasa, Kawasaki (JP); Akihiro Suzuki, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/412,776

(22) Filed: Apr. 28, 2006

(30) Foreign Application Priority Data
Dec. 27, 2005 (JP) 2005-376080

(51) Int. Cl. G06Q 30/00

(52) U.S. Cl. 705/26

(57) ABSTRACT

An ordering system of a purchaser system registers order-item receiving procedure judgment information, indicating whether an in-transit inventory management is performed, in a collation pattern master database on a collation pattern master server. A shipping system of a supplier system sets the order-item receiving procedure judgment information based on a transportation time from shipment to delivery. An order-item receiving system of the purchaser system switches a sequence of a warehousing-and-inspection confirmation process and an invoice collation process based on the order-item receiving procedure judgment information.

### BACKGROUND OF THE INVENTION

1 Field of the Invention

The present invention relates to a technology for resolving a discrepancy between credit and debt at an early stage when a long period is required for transportation of a shipment, and enabling an accurate management of inventory.

2 Description of the Related Art

In a typical ordering and order-receiving system, an ordering system of a purchaser issues a purchasing slip and an order-receiving system of a supplier receives the purchasing slip and performs an order entry process. When the supplier ships an order item, a shipping system of the supplier issues an invoice. After the order item shipped from the supplier is warehoused and undergoes an inspection confirmation process, an order-item receiving system of the purchaser collates invoice data received from the shipping system with purchasing data of the purchasing slip and performs a payment process.

In addition, an integrated distribution and payment system has been developed, which intends to accelerate settlement-related transactions by sharing information between a distribution system for shipment and delivery of a product and a payment system for paying for the product has (see, for example, Japanese Patent Application Laid-open No. 2003-196571).

However, in a conventional order-item receiving system, credit is generated upon shipment on the supplier and debt is generated upon collation of the invoice data and the purchasing data on the purchaser. Therefore, when a long period is required for transportation, such as when the supplier transports a shipment overseas by ship, a discrepancy between the credit and the debt extends for a long period of time.

At the same time, if the credit and the debt are generated upon shipment of the order item by the supplier to eliminate the period of the discrepancy between the credit and the debt, the cargo being transported is considered to be a part of the purchaser inventory. Therefore, an order item that has not actually been delivered is considered to be in stock, which may cause an erroneous shipment and a discrepancy between the actual inventory and the inventory in a system during an inventory check.

### SUMMARY OF THE INVENTION

It is an object of the present invention to at least solve the problems in the conventional technology.

A computer-readable recording medium according to one aspect of the present invention stores a computer program for processing processes relating to receiving an order item. The computer program causes a computer to execute sequence determining including determining a sequence for a collation process between purchasing information and invoice information related to the order item and an inspection process on the order item; and executing the collation process and the inspection process based on the sequence determined at the sequence determining.

An order-item receiving method according to another aspect of the present invention includes sequence determining including determining a sequence for a collation process between purchasing information and invoice information related to an order item and an inspection process on the order item; and executing the collation process and the inspection process based on the sequence determined at the sequence determining.

An order-item receiving apparatus according to still another aspect of the present invention includes a collation-inspection sequence determining unit that determines a sequence for a collation process between purchasing information and invoice information related to an order item and an inspection process on the order item; and a collation-inspection executing unit that performs the collation process and the inspection process based on the sequence determined by the collation-inspection sequence determining unit.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a schematic for illustrating a system configuration of an ordering and order-item receiving system according to an embodiment of the present embodiment;

FIG. 2 is a table of an example of a collaboration pattern master database;

FIG. 3 is a table of an example of purchasing slip data;

FIG. 4 is a table of an example of warehousing confirmation data;

FIG. 5 is a table of an example of order reception slip data;

FIG. 6 is a table of an example of shipment slip data;

FIG. 7 is a table of an example of delivery confirmation data;

FIG. 8 is a table of an example of invoice data;

FIG. 9 is a flowchart of a processing procedure for an ordering process procedure by an ordering system;

FIG. 10 is a flowchart of a processing procedure for an order-item shipment process by a supplier system;

FIG. 11 is a flowchart of a processing procedure for the shipment process shown in FIG. 10;

FIG. 12 is a flowchart of a processing procedure for an order-item receiving process by an order-item receiving system; and

FIG. 13 is a block diagram of a computer that executes an order-item receiving program according to the present embodiment.

### DETAILED DESCRIPTION OF THE PREFERRED EMBODIMENTS

Exemplary embodiments of the present invention are explained in detail below with reference to the accompanying drawings.

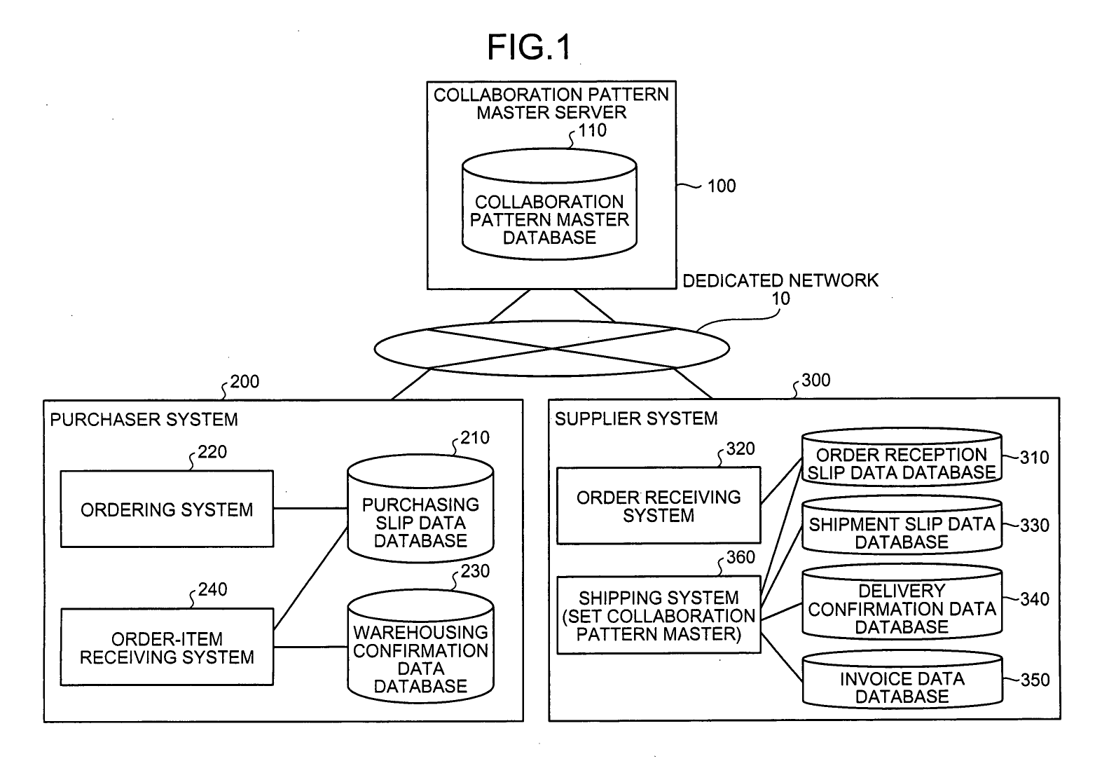

FIG. 1 is a schematic for illustrating a system configuration of an ordering and order-item receiving system according to an embodiment of the present embodiment. In the ordering and order-item receiving system according to the present embodiment, a collaboration pattern master server 100, a purchaser system 200, and a supplier system 300 are connected via a dedicated network 10.

The collaboration pattern master server 100 manages information on a purchasing item that is handled as an in-transit inventory through collaboration between the purchaser system 200 and the supplier system 300, and includes a collaboration pattern master database 110 that stores information of the purchasing item that is handled as the in-transit inventory. The in-transit inventory is a shipment shipped by the supplier that is in transit. In the ordering and order-item receiving system according to the present embodiment, a shipment in transit is differentiated from an actual inventory for which warehousing inspection has been performed by the purchaser, and is handled as the in-transit inventory.

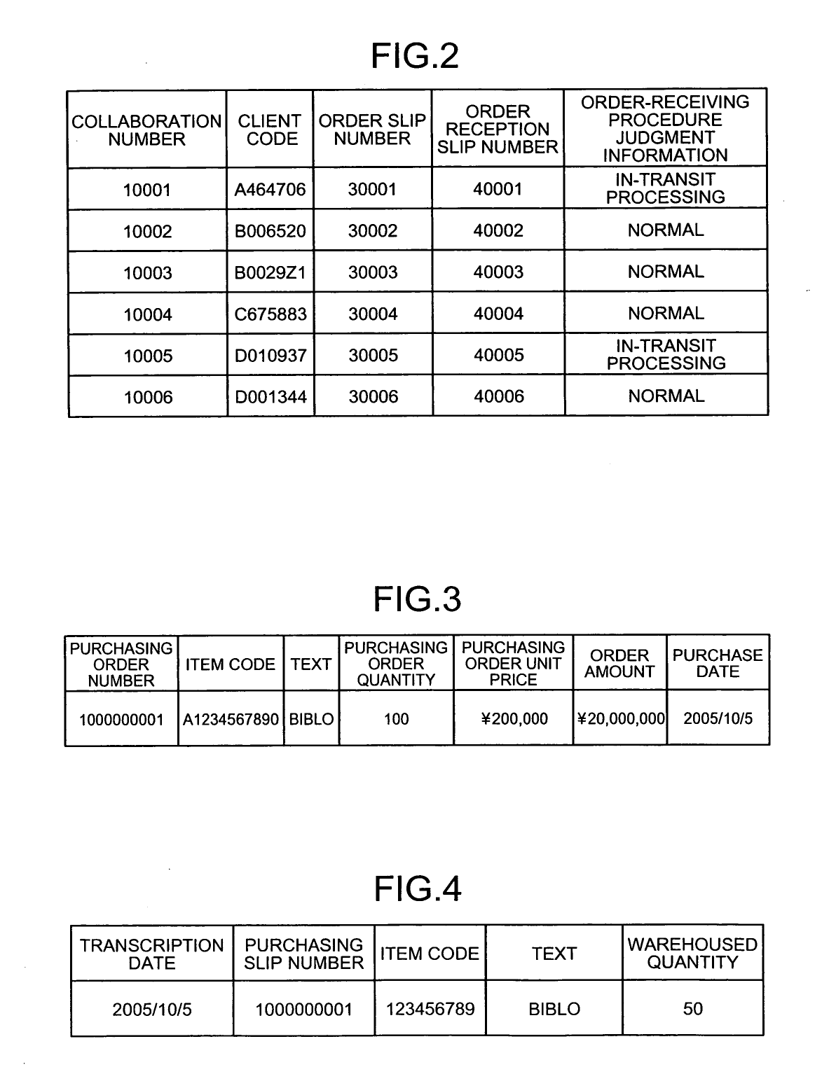

FIG. 2 is a table of an example of the collaboration pattern master database 110. The collaboration pattern master database 110 stores a collaboration number identifying collaboration, a client code identifying the purchaser, an order slip number that is the number of the purchasing slip of the purchaser, an order reception slip number that is the slip number of the supplier, and order-item receiving procedure judgment information indicating whether an order item is managed as an in-transit inventory.

The order-item receiving procedure judgment information is information indicating whether an item is managed as an in-transit inventory. In the ordering and order-item receiving system according to the present embodiment, the sequence of a process for collating purchasing slip data and invoice data and a warehousing-and-inspection confirmation process differs in the order-item receiving process according to a condition whether an item is managed as the in-transit inventory. Therefore, shipment judgment information, that is information used to judge whether to manage the item as the in-transit inventory, is referred to as the order-item receiving procedure judgment information.

If the order-item receiving procedure judgment information is “In-transit processing”, an in-transit inventory control is performed. If the order-item receiving procedure judgment information is “Normal”, the in-transit inventory control is not performed. In this way, the purchaser system 200 and the supplier system 300 can manage in-transit inventory in collaboration by storing information indicating whether the item is managed as the in-transit inventory as the order-item receiving procedure judgment information in the collaboration pattern master database 110.

The purchaser system 200 orders a purchasing item, receives the item, and makes a payment for the item. The purchaser system 200 includes a purchasing slip data database 210, an ordering system 220, a warehousing confirmation data database 230, and an order-item receiving system 240.

The purchasing slip data database 210 is a database storing purchasing slip data. FIG. 3 is a table of an example of the purchasing slip data. The purchasing slip data includes a purchasing order number identifying a purchasing order, an item code identifying an order item, text indicating the name of the order item, a purchasing order quantity indicating the quantity of orders, a purchasing order unit price indicating the price of the order item, an order amount that is the product of the purchasing order quantity and the purchasing order unit price, and a purchase date indicating a deadline for purchasing.

The ordering system 220 creates the purchasing slip data and stores the data in the purchasing slip data database 210, as well as issuing the purchasing slip. In addition, the ordering system 220 receives an instruction from the purchaser on whether management of in-transit inventory will be performed with the supplier when issuing the purchasing slip and registers the instruction as the order-item receiving procedure judgment information in the collaboration pattern master database 110 of the collaboration pattern master server 100, in addition to the client code, the order slip number, etc.

The ordering system 220 can determined the sequence of the process for collating the purchasing slip data and the invoice data and the warehousing-and-inspection confirmation process while receiving the order item with the instruction from the purchaser on whether management of in-transit inventory will be performed with the supplier, when issuing the purchasing slip and registering the instruction as the order-item receiving procedure judgment information in the collaboration pattern master database 110.

The warehousing confirmation data database 230 is a database for storing warehousing confirmation data that is information on an order item to which the warehousing-and-inspection confirmation process has been performed. FIG. 4 is a table of an example of the warehousing confirmation data. The warehousing confirmation data includes a transcription date that is the date on which the warehousing-and-inspection confirmation process was performed, a purchasing slip number identifying the purchasing slip, the item code, text, and a warehoused quantity that is the quantity of items warehoused.

The order-item receiving system 240 performs the warehousing-and-inspection confirmation process, stores the warehousing confirmation data in the warehousing confirmation data database 230, and performs processes related to the receipt of an order item, such as the collation process of the purchasing slip data and the invoice data.

The order-item receiving system 240 determines whether to perform management of the in-transit inventory, namely, the sequence of an invoice collation process for collating the purchasing slip data and the invoice data and the warehousing-and-inspection confirmation process, with reference to the order-item receiving procedure judgment information in the collaboration pattern master database 110. Specifically, the order-item receiving system 240 performs the invoice collation process before the warehousing-and-inspection confirmation process when the order-item receiving procedure judgment information is “In-transit processing” and performs the invoice collation process after the warehousing-and-inspection confirmation process, as in conventional systems, when the order-item receiving procedure judgment information is “Normal”.

The order-item receiving system 240 performs the invoice collation process before the warehousing-and-inspection confirmation process when the order-item receiving procedure judgment information is “In-transit processing”. Therefore, debt can be generated at an early stage even when the shipment is in transit, and the period of discrepancy between credit and debt can be shortened.

In addition, the order-item receiving system 240 is configured so that, when the invoice collation process is performed before the warehousing-and-inspection confirmation process, the order item is managed as the in-transit inventory until the inspection confirmation process for the order item is performed.

Because the order-item receiving system 240 is configured so that the order item is managed as the in-transit inventory until the inspection confirmation process for the order item is performed, the inventory can be managed accurately even when the order item is in transit.

The supplier system 300 performs an order receiving process and a shipment process. The supplier system 300 includes an order reception slip data database 310, an order receiving system 320, a shipment slip data database 330, a delivery confirmation data database 340, an invoice data database 350, and a shipping system 360.

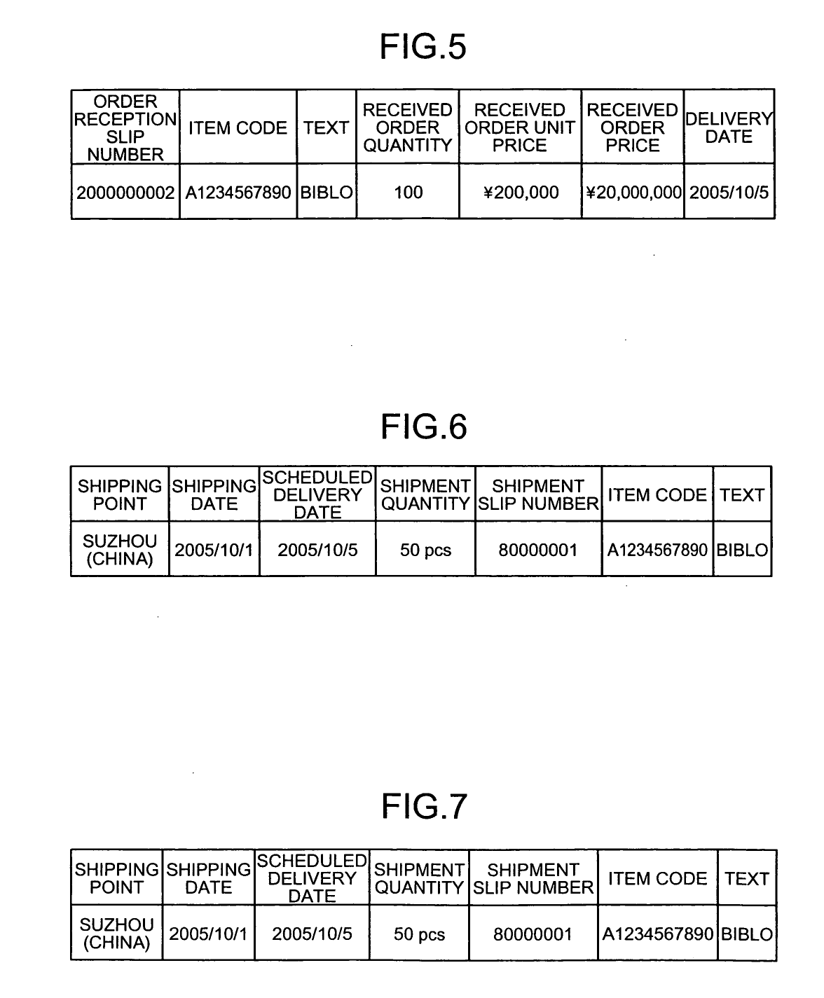

The order reception slip data database 310 is a database for storing order reception slip data. FIG. 5 is a table of an example of the order reception slip data. The order reception slip data includes an order reception slip number identifying the order reception slip, the item code, text, a received order quantity indicating the quantity of received orders, a received order unit price indicating the unit price of the order item, a received order price that is the product of the received order quantity and the received order unit price, and a delivery date indicating a deadline for delivery.

The order receiving system 320 receives the purchasing slip issued by the ordering system 220 of the purchaser, creates an order reception slip data, and stores the data in the order reception slip data database 310. In addition, the order receiving system 320 writes the order reception slip number issued when creating the order reception slip data in a corresponding entry in the collaboration pattern master database 110.

The shipment slip data database 330 is a database for storing shipment slip data used when making a shipment. FIG. 6 is a table of an example of the shipment slip data. The shipment slip data includes a shipping point indicating a shipping destination, a shipping date, a scheduled delivery date, a shipment quantity indicating the quantity of shipments, a shipment slip number identifying the shipment slip, the item code, and text.

The delivery confirmation data database 340 is a database for storing delivery confirmation data used for dispatch. FIG. 7 is a table of an example of the delivery confirmation data. The delivery confirmation data includes the same information as that included in the shipment slip data, shown in FIG. 6.

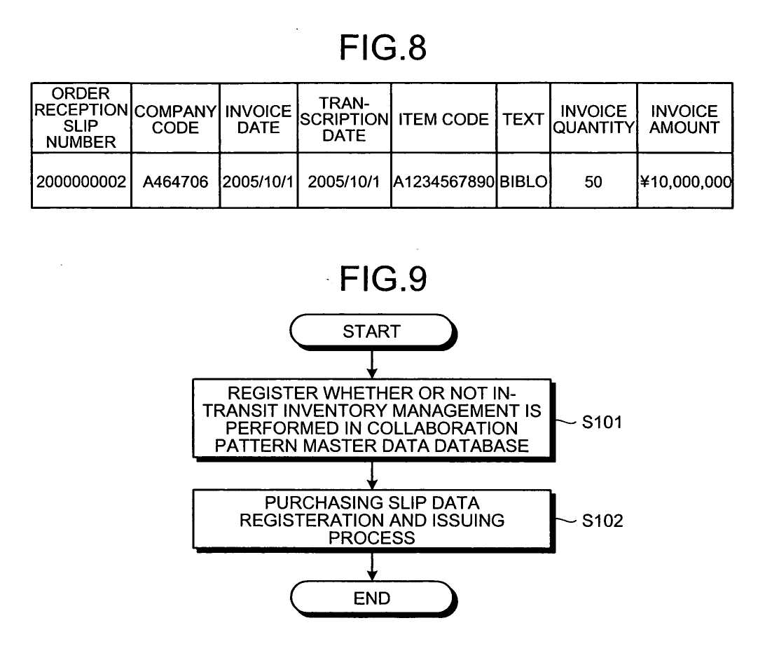

The invoice data database 350 is a database for storing data of the invoice issued to the purchaser. FIG. 8 is a table of an example of the invoice data. The invoice data includes the order reception slip number, a company code identifying the supplier, an invoice date indicating the shipping date, a transcription date that is the invoice creation date, the item code, text, the invoice quantity indicating the quantity of shipment items being invoiced, and an invoice amount.

The shipping system 360 performs processes related to shipment and processes related the issuing of invoices. In addition, the shipping system 360 sets the time required from shipment to delivery that is calculated from the shipping date and the scheduled delivery date in the shipment slip data, namely, the order-item receiving procedure judgment information, in a corresponding entry in the collaboration pattern master database 110, based on whether the transportation time exceeds a designated amount of time.

The shipping system 360 sets the order-item receiving procedure judgment information to “In-transit processing” when the transportation time exceeds the designated amount of time and sets the order-item receiving procedure judgment information to “Normal” at other times.

Because the shipping system 360 sets the order-item receiving procedure judgment information to “In-transit processing” when the transportation time exceeds the designated amount of time, the order-item receiving system 240 can determine the sequence of the invoice collation process and the warehousing-and-inspection confirmation process based on the order-item receiving procedure judgment information.

Although the order-item receiving procedure judgment information is set to “In-transit processing” unconditionally when the transportation time exceeds the designated amount of time, the purchaser can specify “In-transit processing” when placing an order, and additionally, can set the order-item receiving procedure judgment information to “In-transit processing” when the transportation time exceeds the designated amount of time.

FIG. 9 is a flowchart of a processing procedure for an ordering process procedure by the ordering system 220. The ordering system 220 receives an instruction from the purchaser on whether in-transit inventory management will be performed and registers the instruction in the collaboration pattern master database 110 (Step S101).

Then, the ordering system 220 creates the purchasing slip data and registers the data to the purchasing slip data database 210, as well as transmitting the purchasing slip data to the supplier system 300 via the dedicated network 10 (Step S102).

The ordering system 220 receives the instruction from the purchaser on whether in-transit inventory management will be performed and registers the instruction in the collaboration pattern master database 110, thereby allowing the purchaser system 200 and the supplier system 300 to perform in-transit inventory management in collaboration.

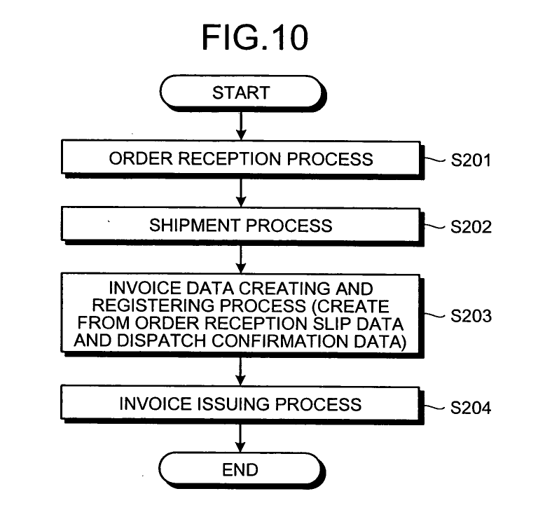

FIG. 10 is a flowchart of a processing procedure for an order-item shipment process by the supplier system 300. In the supplier system 300, the order receiving system 320 performs an order reception process for receiving the purchasing slip data sent from the ordering system 220 (Step S201).

When preparations for the shipment of an order item are completed, the shipping system 360 performs shipment processes, such as creating the shipment slip data and the delivery confirmation data (Step S202), and performs an invoice data creating and registering process, namely, a process for creating invoice data using the order reception slip data and the delivery confirmation data and registering the invoice data in the invoice data database 350 (Step S203).

A shipping system 204 performs an invoice issuing process for transmitting the invoice data to the purchaser system 200, via the dedicated network 10 (Step S204).

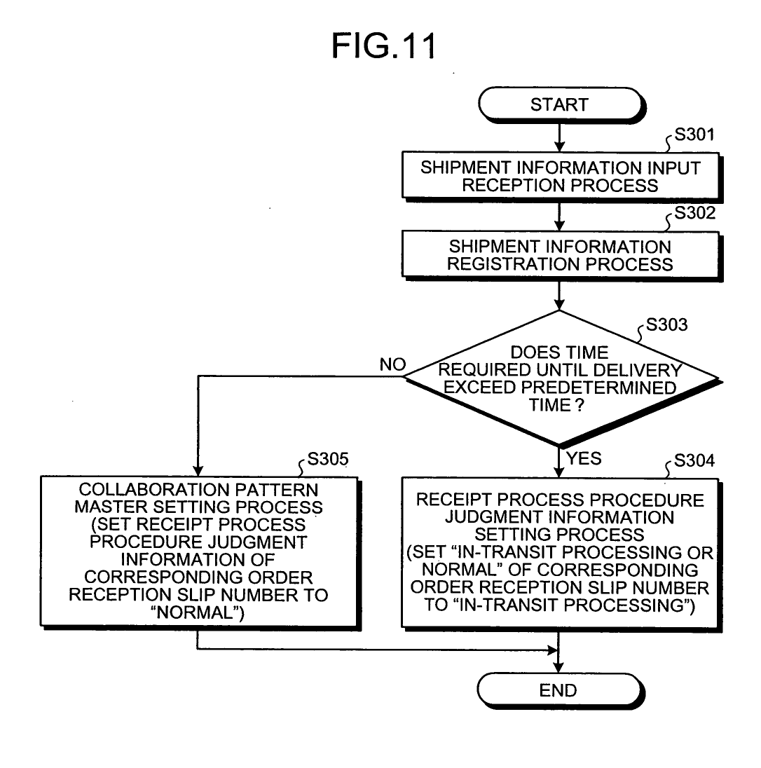

FIG. 11 is a flowchart of a processing procedure for the shipment process shown in FIG. 10. The shipping system 360 performs a shipment information input reception process for receiving shipment information input from a person in charge of shipping instructions (Step S301) and performs a shipment information registration process for creating the shipment slip data form the received shipment information and registering the data in the shipment slip data database 330 (Step S302). In addition, the shipping system 360 also performs a process for creating shipment confirmation data based on a shipment confirmation result and registering the data in the delivery confirmation data database 340, as the shipping information registration process.

Then, it is judged whether the time required from shipment to delivery exceeds a predetermined amount of time, based on the shipment date and the scheduled delivery date in the delivery confirmation data (Step S303). If the required time exceeds the predetermined amount of time, an order-item receiving procedure judgment information setting process, namely, a process for setting the order-item receiving procedure judgment information to “In-transit processing” regardless of whether the order-item receiving procedure judgment information of the corresponding order reception slip number is “In-transit processing” or “Normal”, is performed (Step S304).

At the same time, if the time required from shipment to delivery does not exceed a predetermined amount of time, a collaboration pattern master setting process, namely, a process for setting the order-item receiving procedure judgment information of the corresponding order reception slip number to “Normal”, is performed (Step S305).

The shipping system 360 sets the order-item receiving procedure judgment information in the collaboration pattern master database 110 to “In-transit processing” when the time required from shipment to delivery exceeds a predetermined amount of time, thereby allowing the order-item receiving system 240 of the purchaser system 200 to perform in-transit inventory management.

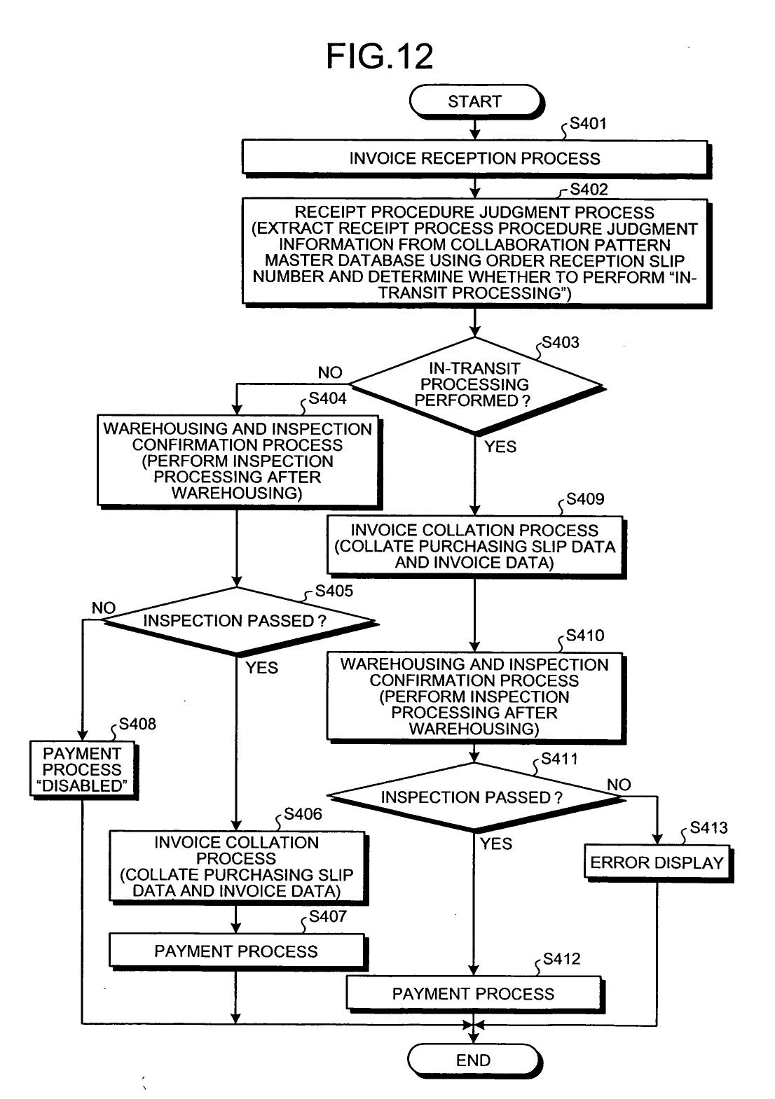

FIG. 12 is a flowchart of a processing procedure for an order-item receiving process by the order-item receiving system 240. In the order-item receiving process, the order-item receiving system 240 performs an invoice reception process for receiving the invoice data transmitted from the shipping system 360 in the supplier system 300 (Step S401).

Then, the order-item receiving system 240 performs a process for extracting the order-item receiving procedure judgment information from the collaboration pattern master database 110, using the order reception slip number in the received invoice data, and judging whether to perform in-transit processing based on the extracted order-item receiving procedure judgment information, namely, whether the order-item receiving procedure judgment information is “In-transit processing” (Step S402).

If the judgment result is not “perform in-transit processing” (“No” at Step S403), the warehousing and inspection process is performed as normal, namely, the inspection process is performed after warehousing (Step S404). Then, whether the inspection is passed is judged (Step S405). If the inspection is passed, the invoice collation process for collating the purchasing slip data and the invoice data is performed (Step S406) and payment processing is performed (Step S407). On the other hand, if the inspection is not passed, the payment process is “disabled” (Step S408).

If the judgment result is “perform in-transit processing” (“Yes” at Step S403), first, the invoice collation processing is performed (Step S409) followed by the warehousing-and-inspection confirmation process (Step S410). Shipment items being transported are handled as in-transit inventory in the invoice collation process.

Then, it is judged whether the order item passed the inspection (Step S411). If the order item passed the inspection, the payment process is performed (Step S412). Otherwise, an error display is performed (Step S413).

The order-item receiving system 240 switches the sequence of the warehousing-and-inspection confirmation process and the invoice collation process based on the order-item receiving procedure judgment information in the collaboration pattern master database 110, in the order-item receiving process, thereby allowing an order-item receiving process suitable for the transportation time of the shipment item.

As explained above, according to the present embodiment, the ordering system 220 of the purchaser system 200 registers the order-item receiving procedure judgment information, indicating whether an in-transit inventory is performed, in the collaboration pattern master database 110 of the collaboration pattern master server 100, based on the instruction from the purchaser. The shipping system 360 of the supplier system 300 sets the order-item receiving procedure judgment information based on the transportation time from shipment to delivery. The order-item receiving system 240 of the purchaser system 200 can switch the sequence of the warehousing and inspection process and the invoice collation process based on the order-item receiving procedure judgment information. Therefore, the invoice collation process can be performed before the warehousing and inspection process when the transportation time is long. Thus, the period of discrepancy between credit and debt can be shortened and inventory management can be performed accurately using in-transit inventory.

Although a situation where the order-item receiving procedure judgment information is shared by the purchaser system 200 and the supplier system 300 using the collaboration pattern master database 110 on the collaboration pattern master server 100 is explained in the present embodiment, the present invention is not limited thereto and can be similarly applied when the order-item receiving procedure judgment information is managed by either the purchaser system 200 or the supplier system 300.

For example, the shipping system 360 of the supplier system 300 can transmit information on the time from shipment to delivery to the purchaser system 200. The purchaser system 200 can judge whether to perform in-transit inventory management and manage the order-item receiving procedure judgment information. Alternatively, the shipping system 360 of the supplier system 300 can judge whether to perform in-transit inventory management based on the time from shipment to delivery, transmit the judgment result to the purchaser system 200, and the result can be managed by the purchaser system 200 as the order-item receiving procedure judgment information.

Although the registration of the order-item receiving procedure judgment information for each purchasing slip in the collaboration pattern master database 110 is explained in the present embodiment, the present invention is not limited thereto and can be similarly applied when, for example, the purchaser system 200 manages the order-item receiving procedure judgment information for each supplier.

Although a system such as the order-item receiving system 240 is explained in the present embodiment, a program having the same functions thereof can be obtained by realizing the configuration of the system by software.

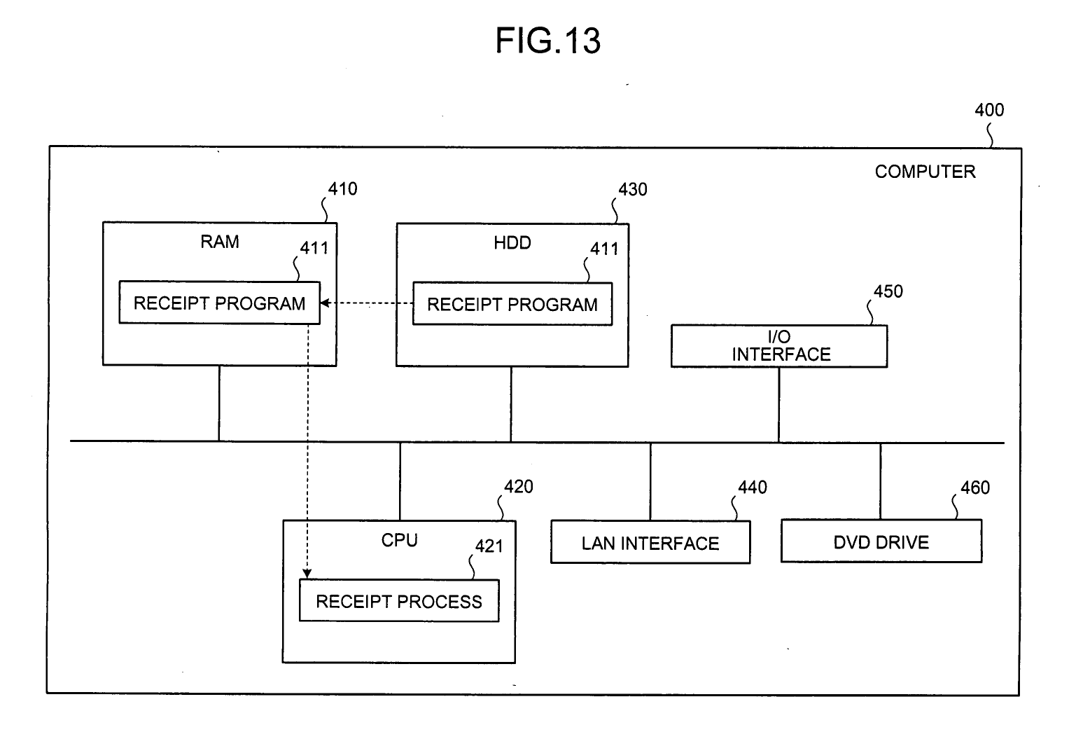

FIG. 13 is a block diagram of a computer 400 that executes an order-item receiving program according to the present embodiment. The computer 400 includes a random access memory (RAM) 410, a central processing unit (CPU) 420, a hard disk drive (HDD) 430, a local-area-network (LAN) interface 440, an input/output (I/O) interface 450, and a digital-versatile-disk (DVD) drive 460.

The RAM 410 is a memory to which programs, intermediate results of the program execution, etc., are loaded. The CPU 420 is a central processing unit that reads out and runs the programs in the RAM 410.

The HDD 430 is a disk device that stores programs and data. The LAN interface 440 is an interface for connecting the computer 400 to another computer via LAN.

The I/O interface 450 is an interface for connecting an input device, such as a mouse or a keyboard, and a display device. The DVD drive is a device for reading from and writing to a DVD.

An order-item receiving program 411 to be executed on the computer 400 is stored on a DVD, read out from the DVD by the DVD drive 460, and installed on the computer 400.

Alternatively, the order-item receiving program 411 is stored in databases of other computers connected via the LAN interface 440. The order-item receiving program 411 is retrieved from the databases and installed on the computer 400.

The installed order-item receiving program 411 is stored in the HDD 430, loaded to the RAM 410, and run the CPU 420 as an order-item receiving process 421.

According to an embodiment of the present invention, the collation process and the inspection process are performed in an appropriate sequence, thereby resolving the discrepancy between credit and debt at an early stage.

Furthermore, according to an embodiment of the present invention, the collation process and the inspection process on an order item requiring in-transit inventory management are performed in an appropriate sequence, thereby resolving the discrepancy between credit and debt at an early stage.

Moreover, according to an embodiment of the present invention, the shipment judgment information is shared with the supplier system that is connected to another computer by the network, thereby resolving the discrepancy between credit and debt at an early stage, in collaboration with the supplier system.

Furthermore, according to an embodiment of the present invention, the collation process and the inspection process are performed in an appropriate sequence. Thus, the collation process is performed before the inspection process when the transit time is long, thereby resolving the discrepancy between credit and debt at an early stage.

Although the invention has been described with respect to a specific embodiment for a complete and clear disclosure, the appended claims are not to be thus limited but are to be construed as embodying all modifications and alternative constructions that may occur to one skilled in the art that fairly fall within the basic teaching herein set forth.

What is claimed is:

1. A computer-readable recording medium that stores a computer program for processing processes relating to receiving an order item, wherein
the computer program causes a computer to execute:
sequence determining including determining a sequence for a collation process between purchasing information and invoice information related to the order item and an inspection process on the order item; and
executing the collation process and the inspection process based on the sequence determined at the sequence determining.

2. The computer-readable recording medium according to claim 1, wherein
the sequence determining includes determining the sequence based on shipment judgment information on whether the order item is managed as an in-transit inventory, when the invoice information is received.

3. The computer-readable recording medium according to claim 2, wherein
the computer program further causes the computer to execute acquiring shipment judgment information from a computer storing the shipment judgment information, via a network, and
the sequence determining includes determining the sequence based on the shipment judgment information acquired at the acquiring.

4. The computer-readable recording medium according to claim 2, wherein
the computer program further causes the computer to execute information determining including determining the shipment judgment information based on a transportation time from shipment to delivery of the order item, and
the sequence determining includes determining the sequence based on the shipment judgment information determined at the information determining.

5. An order-item receiving method comprising:
sequence determining including determining a sequence for a collation process between purchasing information and invoice information related to an order item and an inspection process on the order item; and
executing the collation process and the inspection process based on the sequence determined at the sequence determining.

6. The order-item receiving method according to claim 5, wherein
the sequence determining includes determining the sequence based on shipment judgment information on whether the order item is managed as an in-transit inventory, when the invoice information is received.

7. The order-item receiving method according to claim 6, further comprising:
acquiring shipment judgment information from a computer storing the shipment judgment information, via a network, wherein
the sequence determining includes determining the sequence based on the shipment judgment information acquired at the acquiring.

8. The order-item receiving method according to claim 6, further comprising:
information determining including determining the shipment judgment information based on a transportation time from shipment to delivery of the order item, wherein
the sequence determining includes determining the sequence based on the shipment judgment information determined at the information determining.

9. An order-item receiving apparatus comprising:
a collation-inspection sequence determining unit that determines a sequence for a collation process between purchasing information and invoice information related to an order item and an inspection process on the order item; and
a collation-inspection executing unit that performs the collation process and the inspection process based on the sequence determined by the collation-inspection sequence determining unit.
